(19) United States
(12) Patent Application Publication
(10) Pub. No.: US 2005/0119021 A1
(43) Pub. Date: Jun. 2, 2005

(54) Telephone apparatus and method for call transfer function

(76) Inventors: Jae Hong Ryu, Daejeon-city (KR); Won Ryu, Daejeon-city (KR); Hun Ki Lee, Daejeon-city (KR); Soon Choul Kim, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/937,978

(22) Filed: Sep. 9, 2004

(30) Foreign Application Priority Data
Nov. 28, 2003 (KR) 2003-85831

(51) Int. Cl. H04Q 7/20

(52) U.S. Cl. 455/517

(57) ABSTRACT

A telephone apparatus which allows a wired or wireless telephone subscriber to change a call forwarding telephone number at a remote location, and a call transfer method therefor. The call transfer method includes: receiving a call from an external telephone; determining whether a caller of the external telephone is a valid user; receiving a call forwarding telephone number from the caller; and outputting a call transfer request signal and the received call forwarding telephone number to a switching system.

### BACKGROUND OF THE INVENTION

This application claims the priority of Korean Patent Application No. 2003-85831, filed on Nov. 28, 2003, in the Korean Intellectual Property Office, the disclosure of which is incorporated herein in its entirety by reference.

1. Field of the Invention

The present invention relates to a telephone call transfer service, and more particularly, to a telephone apparatus with a call transfer function permitting a wired or wireless telephone subscriber to change a call forwarding telephone number using a telephone located at a remote location and a method therefor.

2. Description of the Related Art

FIG. 3 is a view for describing a call transfer method between a wired telephone and a wireless telephone according to a conventional technique. When a user stays at home, he/she sets a wired telephone 31 as a call receiver, and when he or she goes out, he/she sets a wireless telephone 32 as a call receiver. Thus, when an external telephone establishes a call with the wired telephone 31 in the state where a call transfer function is activated in the wired telephone 31, a switching system 33 calls the wireless telephone 32 automatically and permits the external telephone to establish a call with the wireless telephone 32.

According to the conventional technique, a user could set a call transfer only through a telephone (wired telephone 31 of FIG. 3) with a call transfer function. Therefore, if the user does not set a call forwarding to the wireless phone using the wired telephone (for example, home telephone) when going out, he/she cannot receive any in-progress telephone call established with the wired telephone.

### SUMMARY OF THE INVENTION

The present invention provides a telephone apparatus with a call transfer function permitting a user to change a call forwarding telephone number using a telephone located at a remote location, and a method therefor.

According to an aspect of the present invention, there is provided a telephone apparatus comprising: a memory, which stores a call forwarding telephone number and a user password; a DTMF identifier, which identifies a number received from an external telephone; a controller, which requires a caller to input a password, determines whether a password received from the caller is the same as that stored in the memory, receives a call forwarding telephone number from the caller, and stores the call forwarding telephone number in the memory; and a call transfer unit, which outputs a call transfer request signal and the call forwarding telephone number stored in the memory, to a switching system.

According to another aspect of the present invention, there is provided a call transfer method comprising: receiving a call from an external telephone; determining whether a caller of the external telephone is a valid user; receiving a call forwarding telephone number from the caller; and outputting a call transfer request signal and the received call forwarding telephone number to a switching system.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a telephone system according to an embodiment of the present invention;

FIG. 2 is a flowchart illustrating a call transfer method according to an embodiment of the present invention; and

FIG. 3 is a view for describing a call transfer method between a wired telephone and a wireless telephone, according to a conventional technique.

### DETAILED DESCRIPTION OF THE INVENTION

Hereinafter, embodiments of the present invention will be described in detail with reference to the appended drawings.

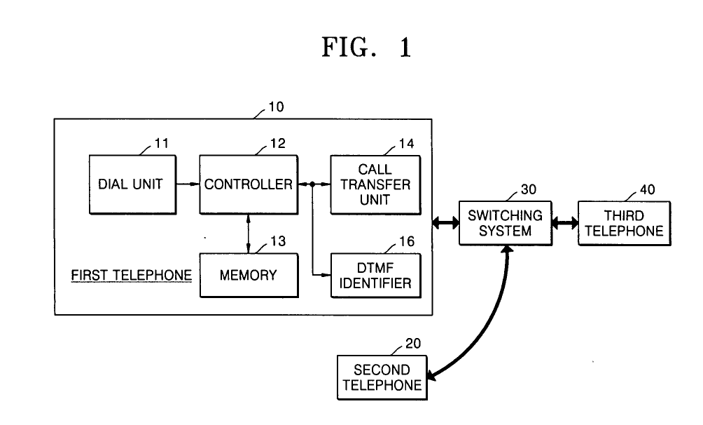

FIG. 1 is a block diagram of a telephone system according to an embodiment of the present invention. Referring to FIG. 1, the telephone system includes a first telephone 10 with a call transfer function and a second telephone 20 as a call forwarding telephone. If an external caller establishes a call with the first telephone 10 in the state where a call forwarding to the second telephone 20 is set by the first telephone 10, a switching system 30 automatically transfers the call to the second telephone 20. Also, according to this embodiment, it is possible to transfer a call received through the first telephone 10 to the second telephone 20 or to an arbitrary different telephone (not shown) using a third telephone 40 located at a remote location.

Here, the first, second and third telephones 10, 20 and 40 are telephones allowing wired or wireless communication. Also, it is assumed in the above-description regarding FIG. 1 that only the first telephone 10 has the call transfer function, however, only the second telephone 20 or both the first and second telephones 10 and 20 can have the call transfer function.

Hereinafter, a call transfer method between the first telephone 10 and the second telephone 20 will be described. The first telephone 10 with a call transfer function includes a memory 13 which stores a telephone number of a second telephone 20 as a call forwarding telephone, a dial unit 11 through which telephone numbers are input and functions are set, a controller 12 which receives a command signal such as a call transfer command, a telephone number, etc. from the dial unit 11 and reads contents stored in the memory 13, and a call transfer unit 14 which outputs a call transfer signal to a switching system 30 under the control of the controller 12.

Here, the call transfer signal is a signal defined in a telephone company and can be composed of “numeral or character (* or #) for call transfer+telephone number of a call forwarding telephone”. For example, the call transfer signal is *88+ telephone number+ * and a call transfer release signal is #88*.

Accordingly, if a user sets call transfer settings through the dial unit 11, the controller 12 sets a call transfer mode, reads a telephone number of a call forwarding telephone (for example, second telephone 20) stored in the memory 13 and outputs the read telephone number to the call transfer unit 14. Then, the call transfer unit 14 transmits a call transfer signal to the switching system 30. If a caller establishes a call with the first telephone 10, the switching system 30 allows the caller to establish a call with the second telephone 20.

Hereinafter, a call transfer system in which a call transfer is performed by a different telephone (referred to as a third telephone 40) will be described.

Referring to FIG. 1, in order to perform a call transfer using an arbitrary third telephone 40 located at a remote location, a first telephone 10 includes a memory 13 which stores a telephone number of a call forwarding telephone and a user password, a controller 12 which requires a caller to input a password if the first telephone 10 receives a call under circumstances that an automatic call transfer function is set, determines whether the password input from the caller is the same as that stored in the memory, receives a call forwarding telephone number from the caller and stores the received telephone number in the memory 13, and a call transfer unit 14 which outputs a call transfer request signal with the call forwarding telephone number stored in the memory 13 to a switching system 30. A DTMF identifier 16 identifies a telephone number received from the external third telephone 40 and provides the telephone number to the controller 12.

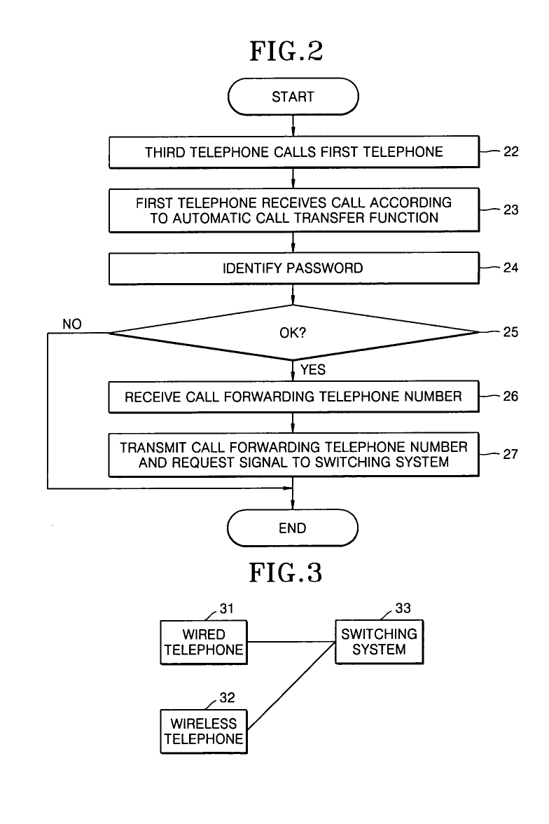

FIG. 2 is a flowchart illustrating a call transfer method in which a call transfer is performed in the first telephone 10 through a call from a third telephone 40, according to an embodiment of the present invention.

Referring to FIG. 2, when a caller establishes a call with the first telephone 10 using the third telephone 40 in step 22, the first telephone 10 with an automatic call transfer function activates its automatic call transfer function the first telephone 10 is not answered within a predetermined time. Meanwhile, a user can set an operation state of the first telephone 10 in advance so that a call forwarding telephone number can be changed.

If a mode of changing a call forwarding telephone number is activated using the third telephone 40, the first telephone 10 requests the caller to input a password in step 24. Requesting the password is to check whether or not the caller is a valid user of the first telephone 10. If such a user authentication is not performed, an arbitrary third party may set call forwarding to a different telephone for a valid user's first telephone.

If the password input by the third telephone 30 is the same as that stored in the first telephone 10 in step 25, the first telephone 10 requires the caller to input a telephone number to be used as a call forwarding telephone number. If the user presses numerals corresponding to a call forwarding telephone number and an input terminating indicator (for example, #) using the third telephone 40, the first telephone 10 identifies the telephone number input from the third telephone 40 and stores the telephone number in the memory 13 in step 26. Identifying the telephone number can be performed by the switching system 30 or the DTMF identifier 16 of the first telephone 10. The call forwarding telephone may be the second telephone 20 or the third telephone 40 or may be a different telephone.

The call transfer unit 14 of the first telephone 10 creates a call transfer request signal and a call transfer signal (for example, *88+telephone number+*) based on the received call forwarding telephone number, and automatically transmits the call transfer signal to the switching system 30 so that the switching system 30 permits the first telephone 10 to perform a call forwarding to the call forwarding telephone when a call transfer request is issued, in step 27.

The memory 13 of the first telephone 10 stores a password for identifying a caller when a call transfer request is received from the third telephone 40 and stores a message to be used for requiring a password or a telephone number.

A telephone which requests a call transfer at a remote location may be the second telephone 20. Also, when the second telephone 20 requests an automatic call forwarding to the second telephone 20, to the first telephone 10, a telephone number pre-stored in the memory 13 can be used. Also, when the third telephone 30 requests an automatic call forwarding to the second telephone 20, to the first telephone 10, a telephone number pre-stored in the memory 13 can be used. Meanwhile, if the first telephone 10 has an Automatic Number Identification (AN I) function, that is, if the first telephone 10 can identify the telephone number of the third telephone 30, the first telephone 10 can perform the automatic call forwarding to the third telephone 30 using a telephone number stored therein without receiving a separate telephone number.

In this disclosure, a call transfer for the first telephone 10 using the third telephone 40 has been illustrated. However, it is also possible that the user performs a call forwarding to a different telephone number for the second telephone 20 which is basically set to perform a call forwarding function with the first telephone 10, using the third telephone 40. That is, if the user sets an automatic call forwarding to the second telephone 20 for the first telephone 10, the third telephone 40 establishes an in-progress telephone call with the second telephone 20 when the third telephone 40 calls the first telephone 10. At this time, the third telephone 40 can perform a call forwarding to an arbitrary different telephone through the second telephone 20 instead of the first telephone 10.

The present invention may be embodied as a program stored on a computer readable medium that can be run on a general computer. Here, the computer readable medium includes but is not limited to storage media such as magnetic storage media (e.g., ROM's, floppy disks, hard disks, etc.), optically readable media (e.g., CD-ROMs, DVDs, etc.), and carrier waves (e.g., transmission over the Internet). The present invention may also be embodied as a computer readable program code unit stored on a computer readable medium, for causing a number of computer systems connected via a network to affect distributed processing.

As described above, according to the conventional technique, a call transfer is performed by activating a call transfer function in advance for a telephone with the call transfer function. However, according to the present invention, by allowing a user to perform a call forwarding to a desired telephone number using an arbitrary telephone, a subscriber using a call transfer function can freely change a call forwarding telephone number using an arbitrary telephone at any location, so that the subscriber can receive all calls through the arbitrary telephone at any location.

Also, according to the conventional technique, when a telephone with a call transfer function receives a call, a call forwarding to a predetermined call forwarding telephone number is performed after the telephone rings a predetermined number of times. However, according to one embodiment of the present invention, a subscriber can set or change a call forwarding telephone number selectively and conveniently regardless of his/her location.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A telephone apparatus comprising:
a memory, which stores a call forwarding telephone number and a user password;
a DTMF identifier, which identifies a number received from an external telephone;
a controller, which requires a caller to input a password, determines whether a password received from the caller is the same as that stored in the memory, receives a call forwarding telephone number from the caller, and stores the call forwarding telephone number in the memory; and
a call transfer unit, which outputs a call transfer request signal and the call forwarding telephone number stored in the memory, to a switching system.

2. A call transfer method comprising:
receiving a call from an external telephone;
determining whether a caller of the external telephone is a valid user;
receiving a call forwarding telephone number from the caller; and
outputting a call transfer request signal and the received call forwarding telephone number to a switching system.

3. The call transfer method of claim 2, wherein the determining whether the caller is the valid user is to require a user to input a password and determine whether a password input by the user is the same as that pre-stored in the memory, in a predetermined time after the call is established.
